(19) United States
(12) Patent Application Publication
(10) Pub. No.: US 2015/0106237 A1
(43) Pub. Date: Apr. 16, 2015

(54) SYSTEM FOR DESIGN OF DRIP IRRIGATION SYSTEM

(71) Applicants: Steele Lorenz, Green Bay, WI (US); Sri Latha Ganti, Shakopee, MN (US)

(72) Inventors: Steele Lorenz, Green Bay, WI (US); Sri Latha Ganti, Shakopee, MN (US)

(21) Appl. No.: 14/513,177

(22) Filed: Oct. 13, 2014

Related U.S. Application Data
(60) Provisional application No. 61/889,532, filed on Oct. 11, 2013.
(60) Provisional application No. 61/969,969, filed on Mar. 25, 2014.

(51) Int. Cl. G06Q 30/06; G06F 17/50

(52) U.S. Cl. CPC G06Q 30/0635; G06F 17/50
USPC 705/26.81

(57) ABSTRACT

A system for enabling the rapid design and deployment of field-specific drip irrigation systems. More specifically, a system wherein a user can input measurements and limitations as to a specific field, and the disclosed system can provide a unique, actionable blueprint for a field owner as well as information relating to materials needed, instructions for how to assemble materials and install the drip irrigation system, cost estimates, and a payment platform allowing for immediate purchase of materials.

### CROSS-REFERENCE TO RELATED APPLICATIONS

This application claims the benefit of U.S. Provisional Application No. 61/889,532 filed Oct. 11, 2013, titled SYSTEM FOR DESIGN OF DRIP IRRIGATION SYSTEM; and claims the benefit of U.S. Provisional Application No. 61/969,969 filed Mar. 25, 2014, titled SYSTEM FOR DESIGN OF DRIP IRRIGATION SYSTEM.

### FIELD OF THE DISCLOSURE

The present invention generally relates to a system and method for enabling the rapid design and deployment of field-specific drip irrigation systems. A user can input measurements and limitations as to a specific field, and the disclosed system can provide a unique, actionable blueprint for a field owner to use to determine products to purchase and steps to take to install a drip irrigation system.

### BACKGROUND OF THE INVENTION

In many rural areas of the world, small-plot farmers rely on flood irrigation, whereby farmers must disperse water over a farm field broadly and cannot direct water just to seedlings or plants. This method wastes water, stunts crops, and washes away valuable soil nutrients. Drip irrigation, on the other hand, allows a farmer precise control of the location, volume, and duration of water release.

Drip irrigation can increase efficiency of water and fertilizer use by between 20% and 50% and can increase crop yields by 30% to 100%. Drip irrigation also preserves nutrients in the soil and increases land longevity. Despite these benefits, drip irrigation technology has proliferated to only 5% of arable land.

The most significant barriers to broader use of drip irrigation are the need for (a) customized, field- and crop-specific design and (b) careful, on-site installation. Rural agricultural product dealers typically do not have the extensive fluid mechanics or drip irrigation expertise to design and install drip irrigation systems for customers. For these reasons, wasteful flood irrigation has remained the norm. Therefore, a system is needed that provides customized, field- and crop-specific drip irrigation designs and that aids with on-site installation of the designed drip irrigation system.

### SUMMARY OF THE INVENTION

The disclosed system and methods allow for rapid design and deployment of field-specific drip irrigation systems. For example, dealers, while onsite at a farm, can design and install an efficient, operating drip irrigation system by entering field- and crop-specific measurements and observations into the system through an interactive visual display. The system can then evaluate and return every piece of information needed to design and install an efficiently operating drip irrigations system for that site. This information includes, but is not limited to, designs for fields, a list of materials, instructions for how to assemble the materials, hyper-local cost estimates, and a payment platform allowing for immediate purchase of materials.

### BRIEF DESCRIPTION OF THE DRAWINGS

FIG. 1 is an example graphical user interface showing a mobile interface login screen according to one embodiment of the present invention.

FIG. 2 is an example graphical user interface showing a mobile interface dashboard screen according to one embodiment of the present invention.

FIG. 3 is an example graphical user interface showing a mobile interface home page screen according to one embodiment of the present invention.

FIG. 4 is an example graphical user interface showing a mobile interface dealer detail screen according to one embodiment of the present invention.

FIG. 5 is an example graphical user interface showing a mobile interface order screen according to one embodiment of the present invention.

FIG. 6 is an example graphical user interface showing a mobile interface order filter according to one embodiment of the present invention.

FIG. 7 is an example graphical user interface showing a mobile interface farmer list screen according to one embodiment of the present invention.

FIG. 8 is an example graphical user interface showing a mobile interface screen where a user can enter farmer details and create an entry for a farmer according to one embodiment of the present invention.

FIG. 9A is an example graphical user interface showing a mobile interface screen where a user can enter details to create a drip irrigation design according to one embodiment of the present invention.

FIG. 9B is an example graphical user interface showing system specifications and cost estimates.

FIG. 9C is an example graphical user interface illustrating a flow check and PVC requirements.

FIG. 10A is an example graphical user interface showing a mobile interface drip irrigation design screen according to one embodiment of the present invention.

FIG. 10B is an example graphical user interface showing a functional design of an irrigation system for an agricultural field.

FIG. 10C is an example graphical user interface showing one example of a template field design.

FIG. 10D is an example graphical user interface showing how major pieces may work in an irrigation system designed by the disclosed system.

FIG. 10E is an example graphical user interface showing the process of designing a field through an interactive touch display.

FIG. 11 is an example graphical user interface showing a mobile interface checkout cart screen according to one embodiment of the present invention.

FIG. 12 is an example graphical user interface showing a mobile interface purchase order screen according to one embodiment of the present invention.

FIG. 13 is an example graphical user interface showing a mobile interface saved orders screen according to one embodiment of the present invention.

FIG. 14 is an example graphical user interface showing a mobile interface invoice screen according to one embodiment of the present invention.

FIG. 15 is an example graphical user interface showing a mobile interface screen where a user can send an invoice through email according to one embodiment of the present invention.

FIG. 16 is an example graphical user interface showing a mobile interface products screen according to one embodiment of the present invention.

FIG. 17 is an example graphical user interface showing a mobile interface products option screen according to one embodiment of the present invention.

FIG. 18 is an example graphical user interface showing a mobile interface products option screen according to one embodiment of the present invention.

FIG. 19 is an example graphical user interface showing a mobile interface products option screen according to one embodiment of the present invention.

FIG. 20 is an example graphical user interface showing a mobile interface settings screen where a user can sync data according to one embodiment of the present invention.

FIG. 21 is an example graphical user interface showing a mobile interface settings screen where a user has successfully synced data according to one embodiment of the present invention.

FIG. 22 is an example graphical user interface showing a web interface login screen according to one embodiment of the present invention.

FIG. 23 is an example graphical user interface showing a web interface home page screen according to one embodiment of the present invention.

FIG. 24 is an example graphical user interface showing a web interface dashboard screen according to one embodiment of the present invention.

FIG. 25 is an example graphical user interface showing a web interface dashboard filter according to one embodiment of the present invention.

FIG. 26 is an example graphical user interface showing a web interface order screen according to one embodiment of the present invention.

FIG. 27 is an example graphical user interface showing a web interface order filter according to one embodiment of the present invention.

FIG. 28 is an example graphical user interface showing a web interface report screen according to one embodiment of the present invention.

FIG. 29 is an example graphical user interface showing a web interface report filter according to one embodiment of the present invention.

FIG. 30 is an example graphical user interface showing web interface export options according to one embodiment of the present invention.

FIG. 31 is an example graphical user interface showing a web interface master data screen according to one embodiment of the present invention.

FIG. 32 is a schematic block diagram depicting an example computing system used in accordance with one embodiment of the present invention.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

The system and methods described herein solve the disconnect problem that occurs between the three major players in a drip irrigation design or installation transaction: manufacturers, dealers, and customers. Few dealers have the product knowledge and installation expertise to provide customers with proper drip irrigation systems. Further, if they do have knowledge, prices to farmers usually increase. This occurs because the knowledge that dealers gain usually comes from manufacturing efforts and, when manufacturers must train dealers, the price that dealers charge for the products usually increases. Therefore, because dealers currently have limited availability of products and skill sets, and because prices increase if dealers get trained to sell manufacturer's products, farmers in rural areas of the world with very small budgets have limited accessibility to drip irrigation systems.

The system and method described herein enable the user, most times a dealer, to create and install drip irrigation systems for customers, usually farmers, in any area of the world. Initially, the user inputs one or more field parameters into the system. The system can be used to perform analyses and to design and install site-specific drip irrigation systems.

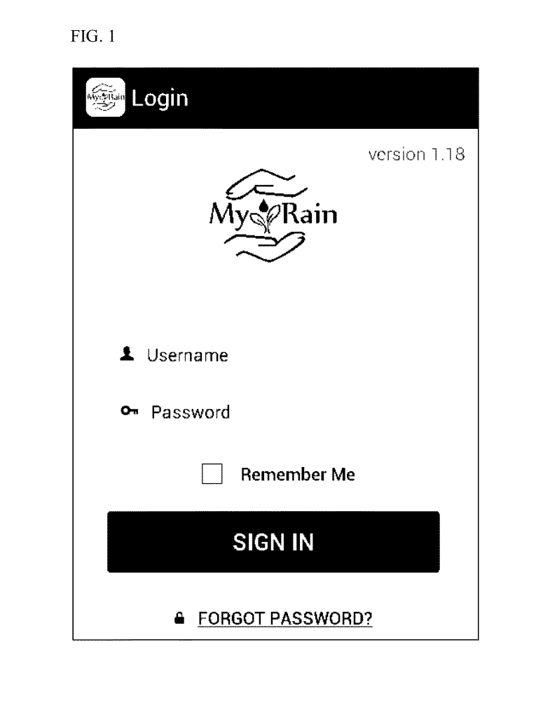

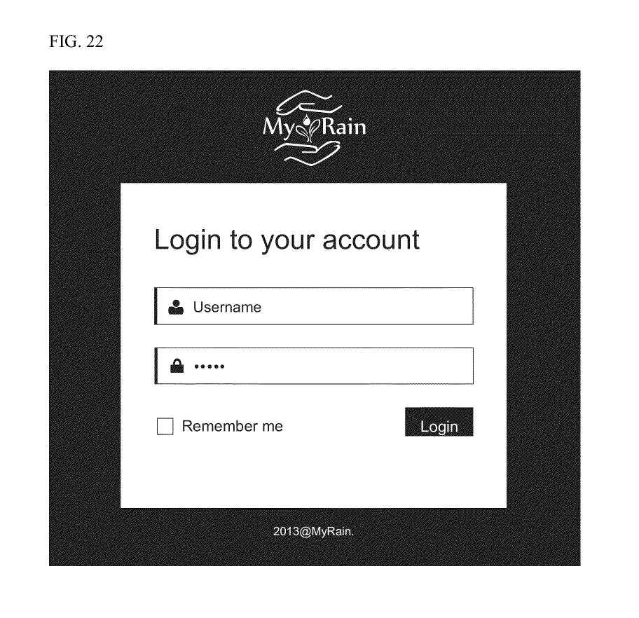

In an example embodiment, a mobile application is provided that can receive user input about a specific agricultural site, determine needed drip irrigation specifications, create a design implementation, evaluate local pump sufficiency, and determine the physical parts needed for installation and operation. FIGS. 1 through 21 illustrate visual features of the disclosed system as an application on a mobile interface. FIGS. 22 through 31 illustrate features of the disclosed system as a webpage on a web interface.

FIG. 1 is an image that illustrates the login process on the mobile application. The application can require the user to enter a username and password and can be enabled to remember the user when he or she opens the application on the same mobile device in the future. When the user has provided a valid username and password, he or she can select the sign in button, and the application can provide the user access to use the remainder of the application.

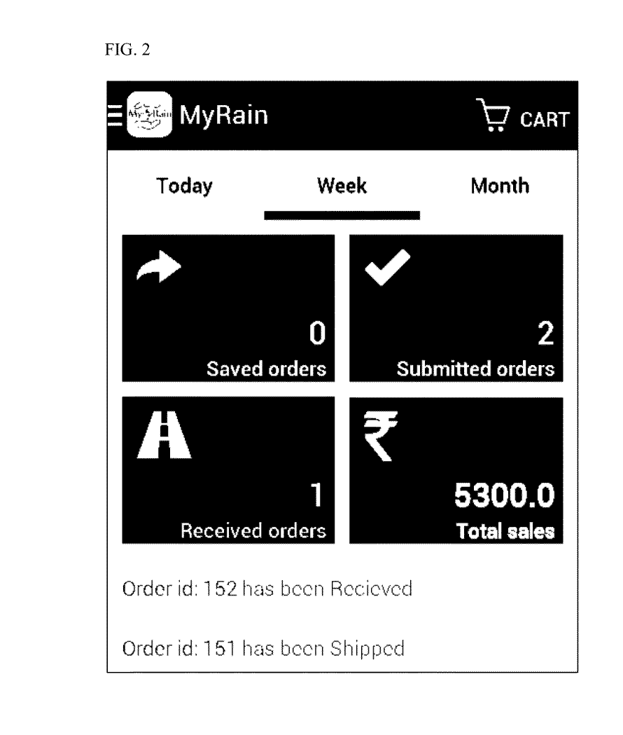

FIG. 2 illustrates the dashboard that a user can see when the user has successfully logged in to the application. The dashboard can display features such as, but not limited to, daily, weekly, and monthly order statistics. For example, a user can see weekly statistics related to saved orders, submitted orders, received orders, and total sales. A user may also be able to see recent updates regarding submitted, received, and shipped orders.

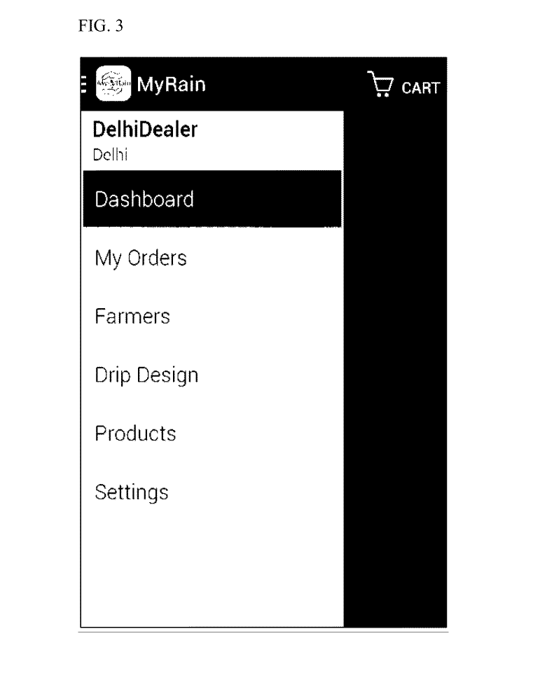

FIG. 3 shows the features that are available on the main page of the application. Some features that the application shows as available for the user to select from the main page include, but are not limited to, a user's or dealer's information page, a dashboard page, a user's order page, a page with detailed information on each farmer who has been saved to the database, a drip design page, a products page, and a settings page. A user can select any of these options to be taken to the corresponding page.

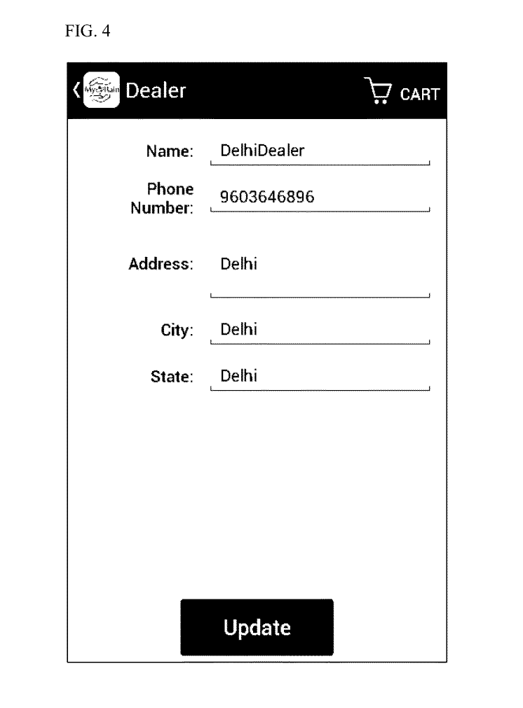

From the main page on the application, as illustrated in FIG. 3, a user can select the dealer's information button to view the current dealer's information that is saved in the application. FIG. 4 is an image that illustrates the page where dealer details can be modified. In one embodiment, a user can edit information such as, but not limited to, his or her name, phone number, address, city, and state. When a user has entered the needed information, the user can select the update button, and the application can save the new information.

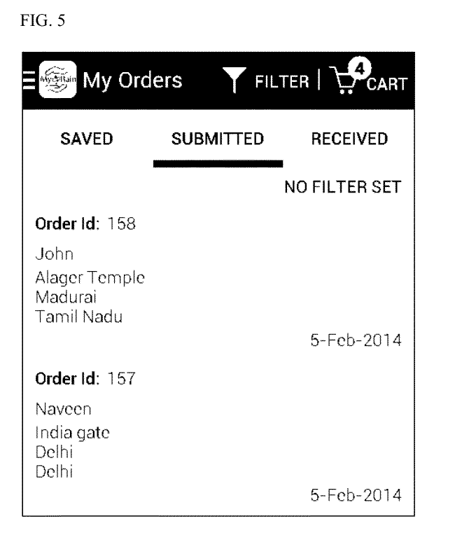

From the main page on the application, as illustrated in FIG. 3, a user can select the “my orders” button to view prior orders made with the application. FIG. 5 illustrates the prior orders page. In one embodiment, the user can view prior orders by selecting one of several available tabs. For example, the application may have three tabs, as illustrated in FIG. 5, one each for saved orders, submitted orders, and received orders. Each tab can contain a list of prior orders with a summary of information from each prior order such as, but not limited to, the order id, name of purchaser, address, city, state, and order date.

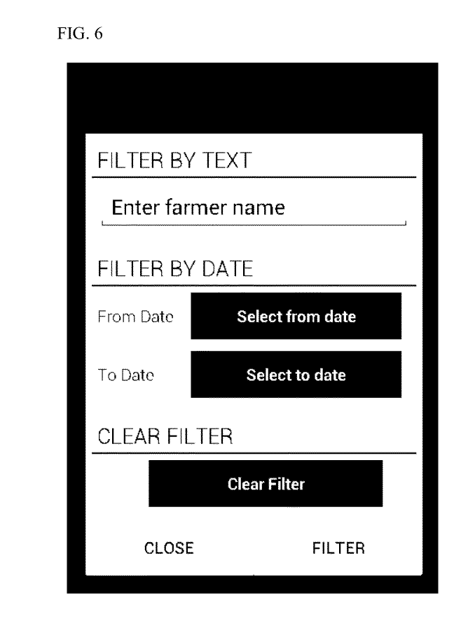

FIG. 6 illustrates how a user can view a subset of prior orders through the use of a filter. For example, a user can select a filter button and filter the displayed orders by farmer name and/or date. Additionally, a user can clear any filters that have been put in place by pressing the clear filter button. When a user has selected the filter he or she wishes to use, he or she can press the filter button to enable the changes to occur. If a user does not wish to make any changes, he or she can press a close or cancel button.

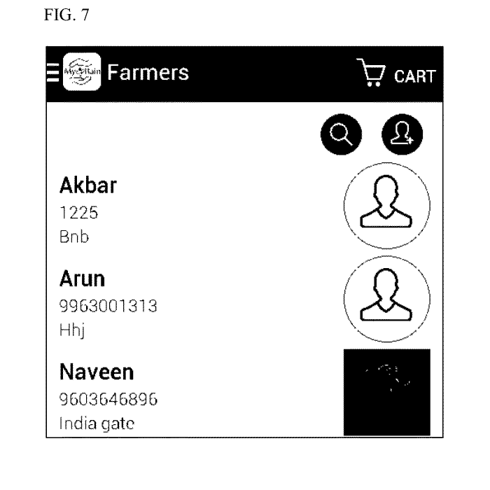

From the main page on the application, as illustrated in FIG. 3, a user can select the “farmers” button to view saved farmer information on the application. FIG. 7 illustrates the “farmers” page as it may appear to a user after selecting the farmers button. On this screen, a user can view the list of all saved farmers and a summary of information for each farmer such as, but not limited to, the farmer's name, phone number, address, and picture. Within this screen, a user can search for, or create, a farmer information page by pressing a search or add button.

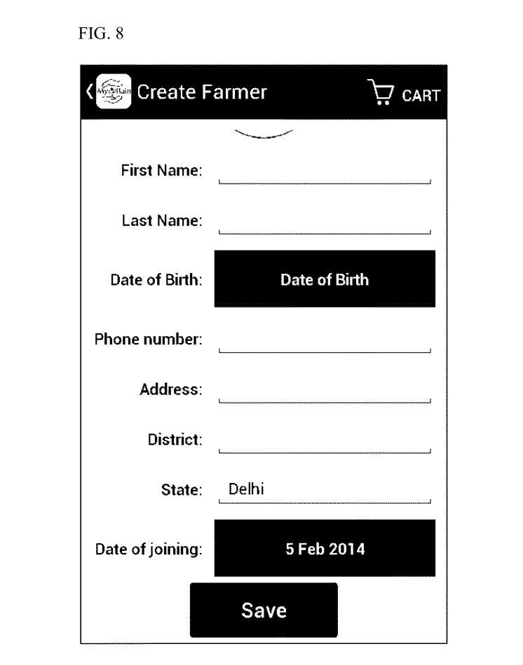

FIG. 8 illustrates the information that a user can input for a new farmer information page. Some information that a user input includes, but is not limited to, first and last name, date of birth, phone number, address, district, state, and date of joining When all of the information has been added, a user can save the new farmer in the system by pressing the save button.

From the main page on the application, as illustrated in FIG. 3, a user can select the drip design button to input specific agricultural field information in order to determine needed drip irrigation specifications, design a drip irrigation system, and determine the physical products that may be necessary for installation and operation of the design.

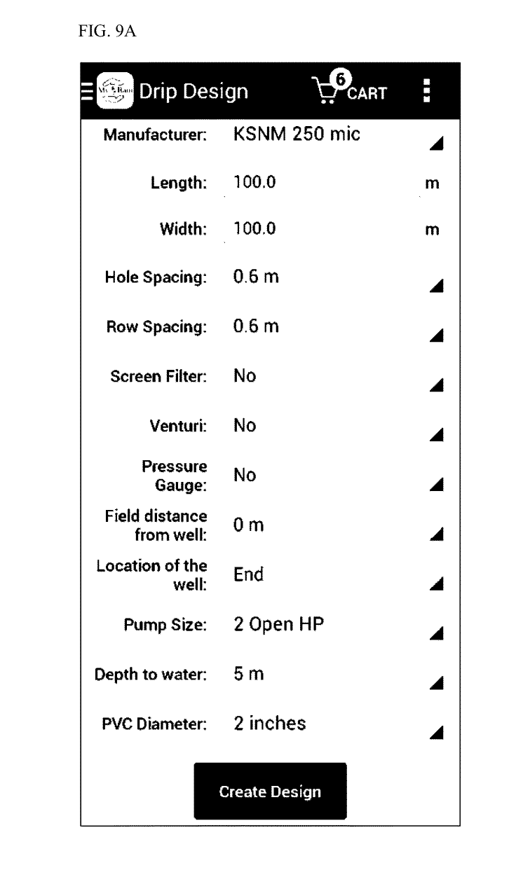

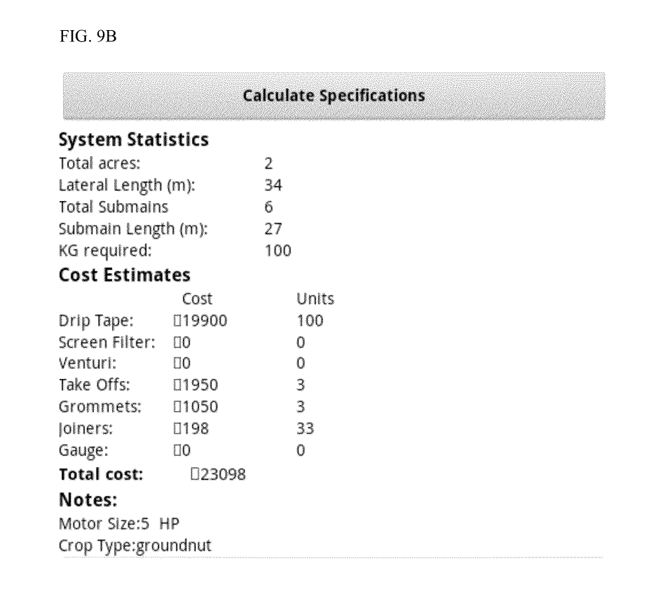

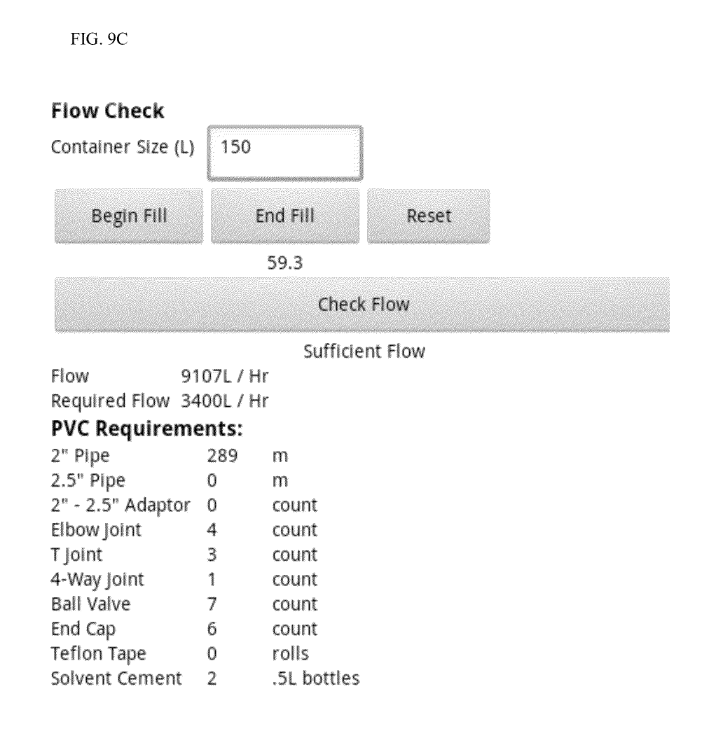

FIG. 9A illustrates the drip design creation page. The system is capable of designing a functional drip irrigation system with information such as, but not limited to, the manufacturer of the equipment, the length and width of a field, hole spacing, row spacing, the presence and number of filters 1004, the presence and number of venturi 1006, the presence of a pressure gauge, the well 1002 location, the distance of the well 1002 from the field, the depth to water, the PVC diameter, the size of the pump, and the crop type. A user can input this information about a customer's field into the system after an onsite inspection, measurement and evaluation. These new inputs can help to determine the pressure at the head of the system as well as the friction loss. Once the above-information is supplied, the system can display the system statistics and cost estimates, as illustrated in FIG. 9B. System statistics may include statistics such as, but not limited to, total acres, lateral length, total submains 1010, submain length, and KG required. Cost estimates may include, but are not limited to, amount and cost of drip tape, filters 1004, venturi 1006, take offs, grommets, joiners, and gauges. Other notes entered by the user may also be displayed such as, but not limited to, the motor size and crop type. Example system statistics and example methods of calculation can include the following:

Total Acres: [one decimal place] ((Length*Width)/4046)

Meters of Drip Tape per Acre: (63/Rowspacing)*63

KG of Drip Tape per Acre: Roundup (Meters of Drip Tape per Acre/Meters per Drip Tape roll)

Maximum Lateral Length: Dependent on product specifications

Maximum Submain Length: Dependent on product specifications

Total KGs of Drip Tape required: (Meters of Drip Tape per Acre/Meters per Drip Tape roll)*Total Acres

Rows of Submains: Length/(Maximum lateral length*2)

Lateral Zone Width: Length/(maximum Submain length)

Lateral Zone Length: Length/(maximum Lateral length)

Total Submains: (Length/(max lateral length*2))*Lateral Zone Width

Actual Lateral Length: Length/Lateral Zone length

Actual Submain Length: Width/Lateral Zone width

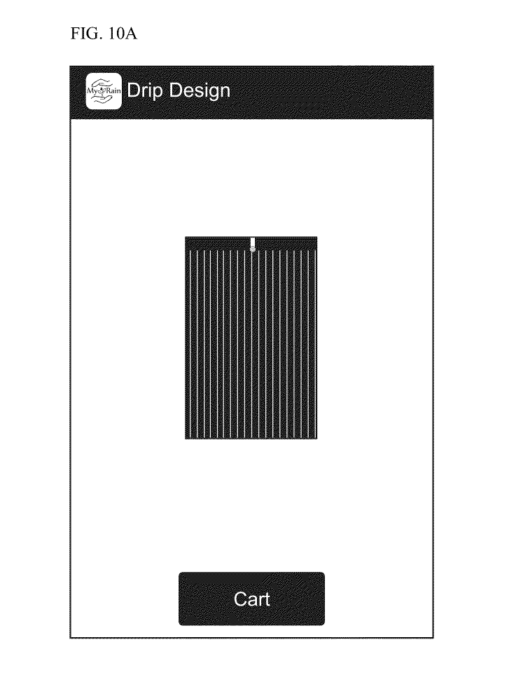

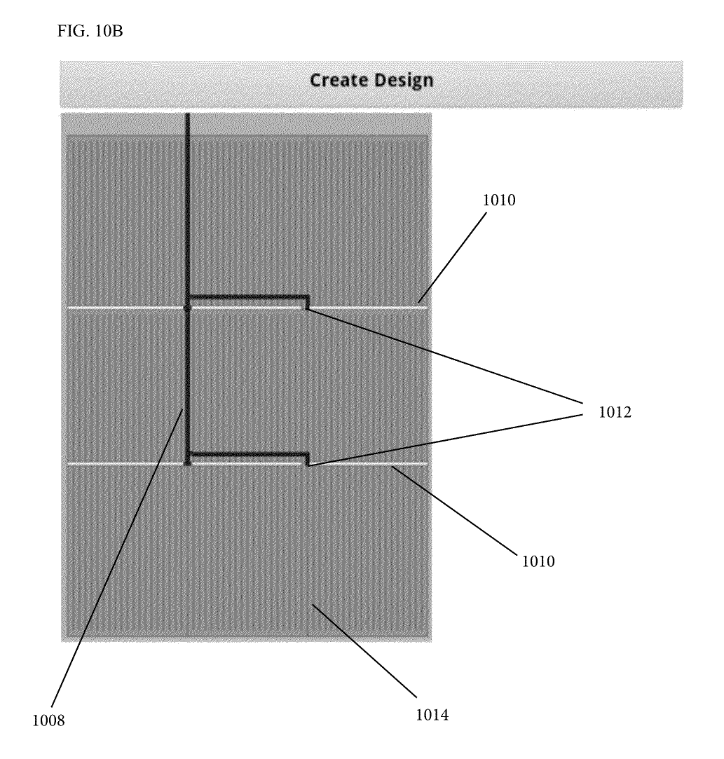

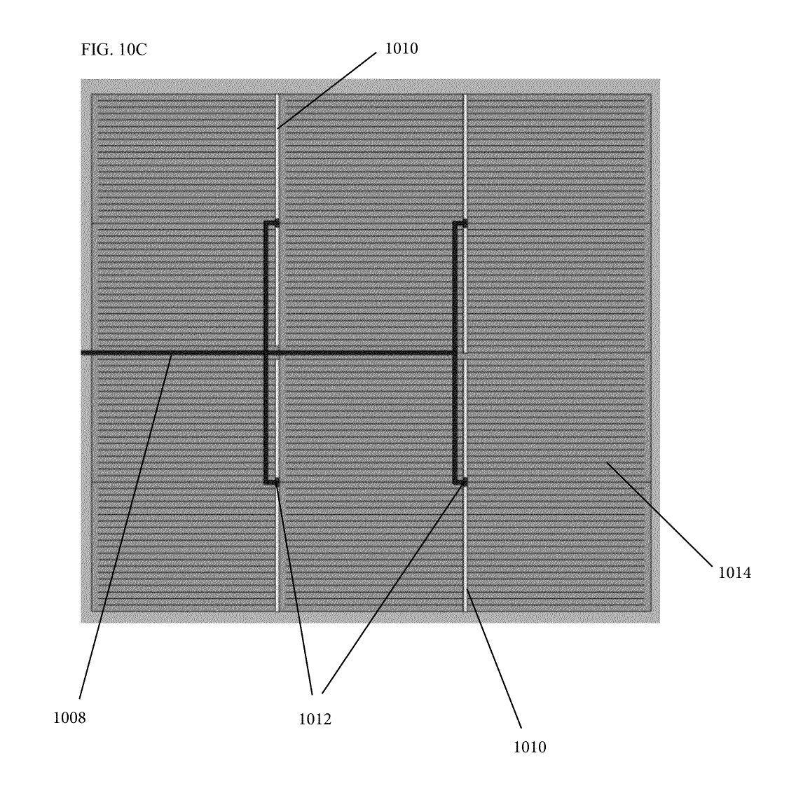

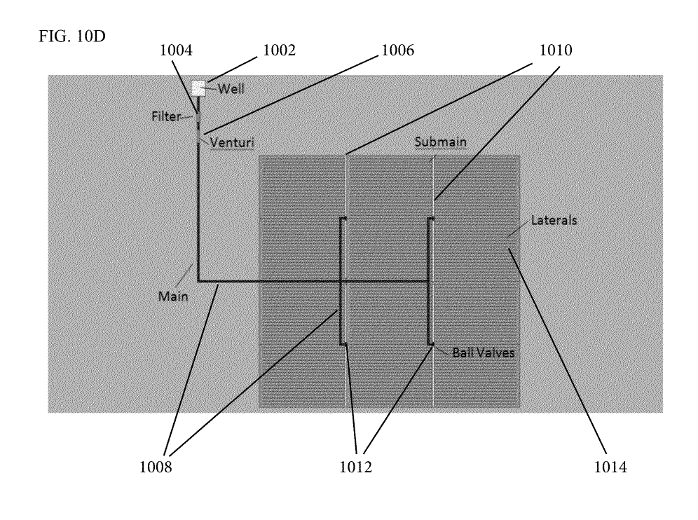

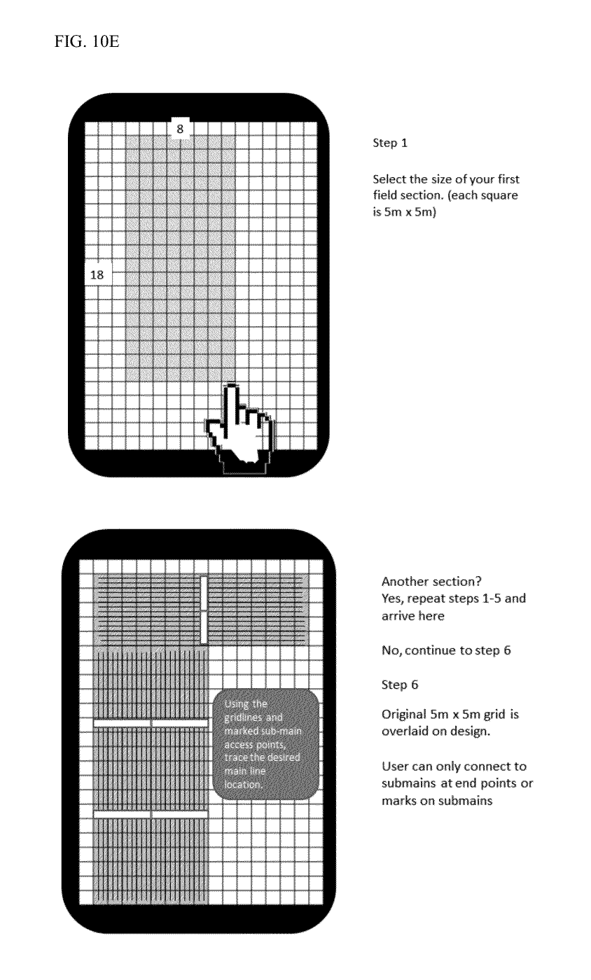

After a user inputs the available information, he or she can select the create design button, and the system can provide a functional design for the field, as illustrated in FIGS. 10A and 10B. The design can provide a basic understanding to the user and the customer of what may be needed for the installation of the irrigation system and how the irrigation system may look after it is installed.

In one embodiment, the system has a database of field design pictures, which it can reference when a user inputs information. One example design is illustrated in FIG. 10C. The design is three lateral zones long and four lateral zones wide with the pipes from the well 1002 entering the field from the end of the rows. Therefore, when the system searches for those characteristics, it can return a corresponding image and image name that is displayed to the user. The system can select the most efficient irrigation field design layout by comparing the inputted information to the characteristics of each field design picture in the system's database. Additionally, once a design has been produced, some of the structural components of the irrigation system can be shown in the functional design, such as, but not limited to, the well 1002, filter 1004, venturi 1006, main 1008, submains 1010, ball valves 1012, and drip laterals 1014, as illustrated in FIG. 10D.

In one embodiment, once the information is inputted into the system and a design is produced, the system can determine whether the on-location water pump is powerful enough to sustain the produced irrigation design. It does this by comparing the measured flow rate of the pump to the required flow rate needed to fully power each lateral 1014, as illustrated in FIG. 9C. FIG. 9C also illustrates how the system can display to the user all of the polyvinyl chloride (PVC) and non-PVC equipment that is necessary for installation of the irrigation system.

After reviewing the design, if the user chooses to go forward with the suggested design, he or she can select the cart button and the system can add the needed products to build the irrigation system to the user's cart. The products provided are based on precise, customized details of the elements and parts needed to build and install the selected irrigation system. The amount and type of equipment added to the cart can be dictated by the information provided by the user and the design that is approved by the user. Further, the system can display how the major pieces may work in a designed irrigation system, as illustrated in FIG. 10D. In one embodiment, the system can also provide instructions on how to assemble the irrigation system. Instructions may be provided after the user inputs information, after selection of a design, after a flow check, or after display of all parts and equipment needed for installation.

In one embodiment, the system can allow for enhanced interactivity of design. For instance, rather than simply receiving various customer field values and generating and displaying a proposed field layout, a user could design the field through an interactive touch display, as illustrated in FIG. 10E. The design options could be affected by pre-entered field values or the system could update such values based on user input. This method may permit the system to design non-rectangular fields, provide dimensions that are not predefine and included in the database, and expand the size of the field that can be designed.

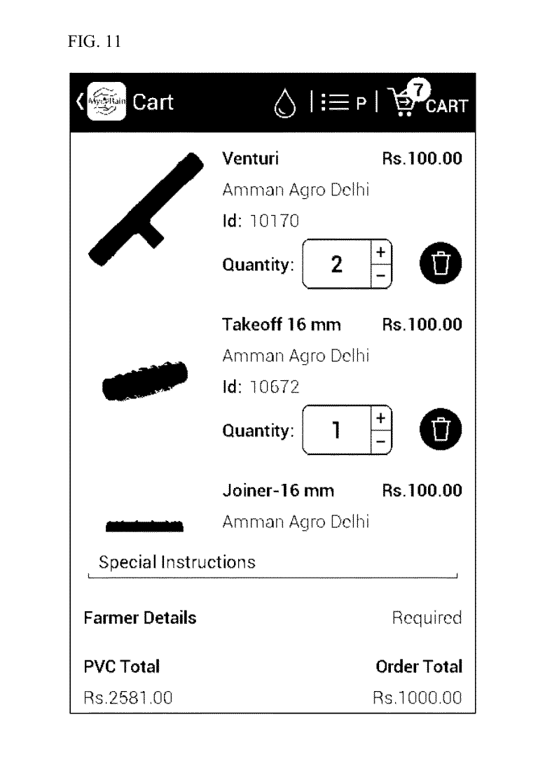

The user can review all of the products added to his or her cart prior to purchasing the products and add or take away products, as illustrated in FIG. 11. Components and parts that the system may suggest are necessary for an irrigation system include, but are not limited to, a water main 1008, submains 1010, takeoffs, a well 1002, laterals 1014, ball valves 1012, grommets, a water pump, 4-way joints, t joints, joiners, drip tape, water filters 1004, venturi 1006, and a pressure gauge. The displayed page can show information about each added product such as, but not limited to, the type of product, the cost per unit of each product, the manufacturer, the product id, and the quantity selected. Additionally, the user has the option of taking a specific product out of his or her cart by selecting the trash button. A user may do this if the parts are already in use. The page also allows a user to input farmer details and to view the total order cost. Once a user has modified the order to his or her satisfaction, he or she can select the buy button on the cart page. Once a user presses buy, the application creates a purchase order.

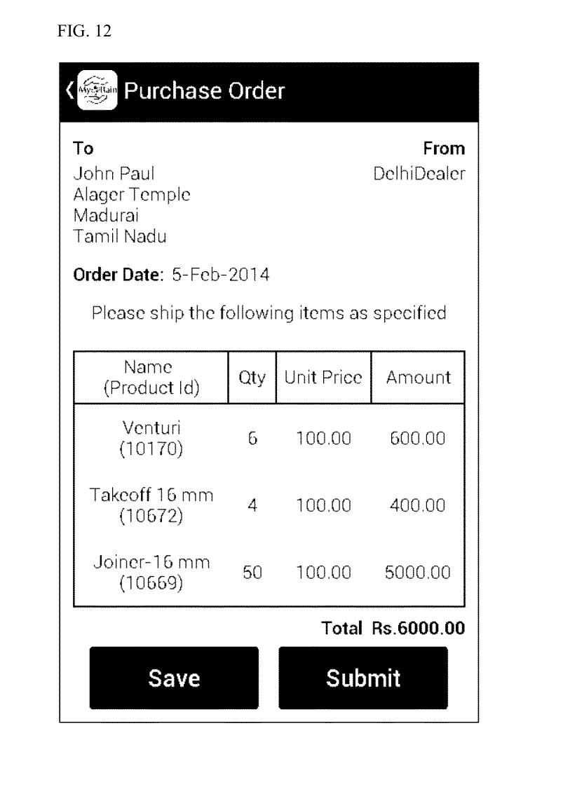

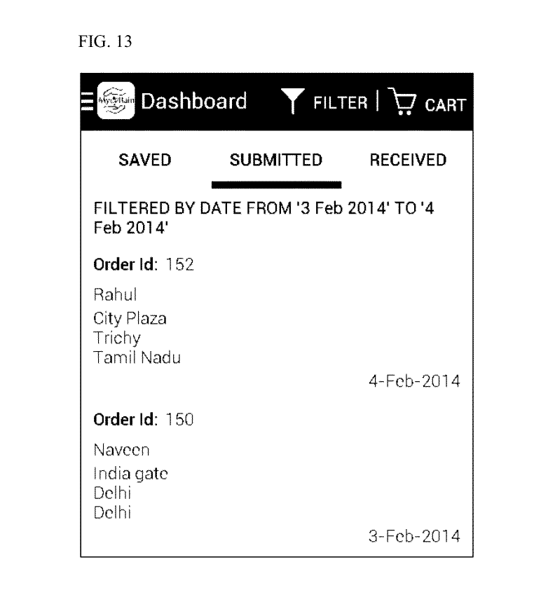

An example of a purchase order is illustrated in FIG. 12. On the purchase order page, a user can view the pending purchase and can either save it or submit it. Saved orders can be stored in the application. Submitted orders can be sent through email for further processing. Details that a user can see regarding a pending order include, but are not limited to, the name, address, city, and state where the order is being sent to, the user/dealer's name, the order date, and a list of the products, products' id, unit price, quantity of units requested, total price for each type of product, and overall total cost. Once a user saves or submits an order, he or she can go back and look at that order in the order screen, as illustrated in FIGS. 5 and 13.

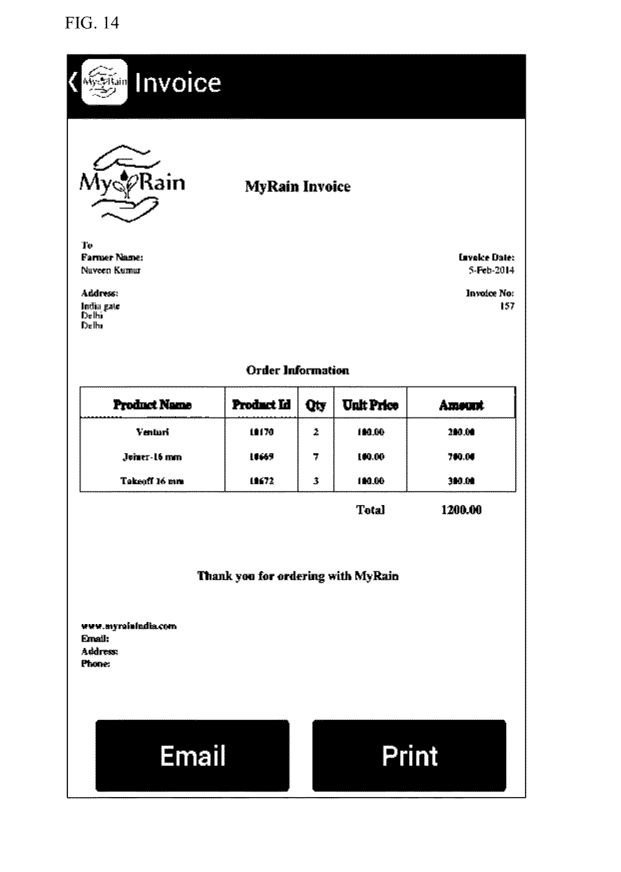

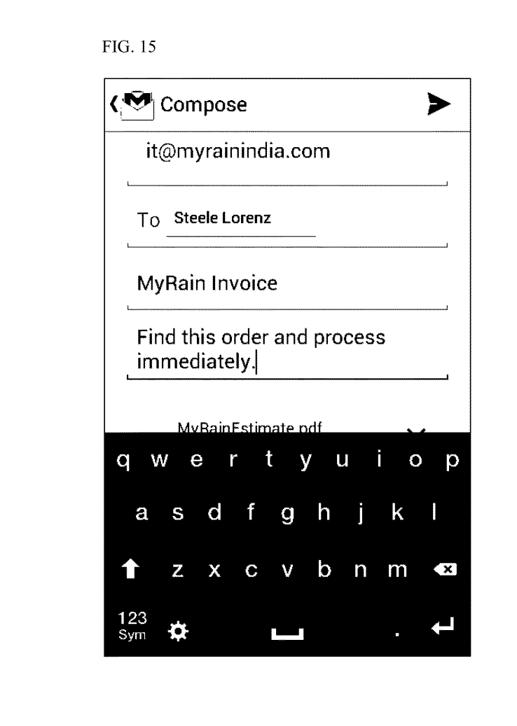

If a user wishes to create an invoice, the user can open a submitted order and select an invoice button. The invoice that is created, as illustrated in FIG. 14, can be emailed or printed, if a printer is physically or wirelessly connected to the application, and includes information similar to that on the purchase order such as, but not limited to, the name, address, city, and state where the order is being sent to, the user/dealer's name, the order date, the invoice number, and a list of products, products' id, unit price, quantity of units requested, total price for each type of product, and overall total cost. An example of an invoice being sent via email is illustrated in FIG. 15. The sender can determine to whom the email is being sent and the subject line and can edit the text in the body of the email. The invoice can be sent as an attachment to the email.

From the main page on the application, as illustrated in FIG. 3, a user can select the products button to view available products to purchase. FIG. 16 illustrates the main products page. In one embodiment, the user can select among products in categories such as, but not limited to, small machinery, sprinkler irrigation system, and drip irrigation system. Further, a user can see how many items are currently in his or her cart.

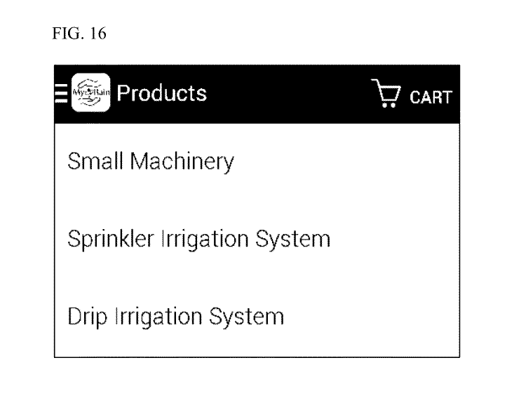

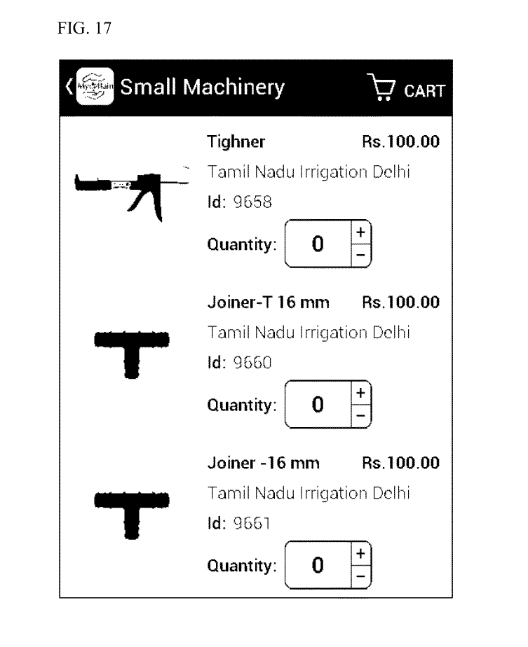

If a user selects the small machinery products option, the application can bring the user to a page that lists the types of small machinery available for purchase, as illustrated in FIG. 17. The list can include information such as, but not limited to, each product's picture, name, manufacturer, product id, unit price, and the quantity selected for purchase by the user. The page can also display the total number of overall products currently selected for purchase.

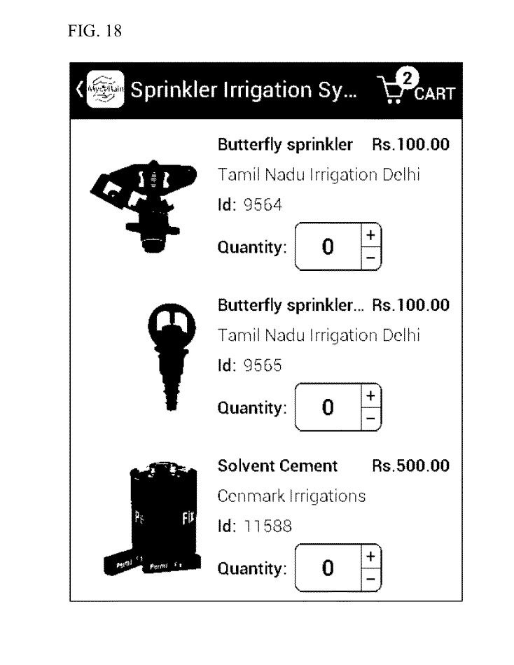

If a user selects the sprinkler irrigation system products option, the application can bring the user to a page that lists the types of sprinkler irrigation system products available for purchase, as illustrated in FIG. 18. The list can include information such as, but not limited to, each product's picture, name, manufacturer, product id, unit price, and the quantity selected for purchase by the user. The page can also display the total number of overall products currently selected for purchase.

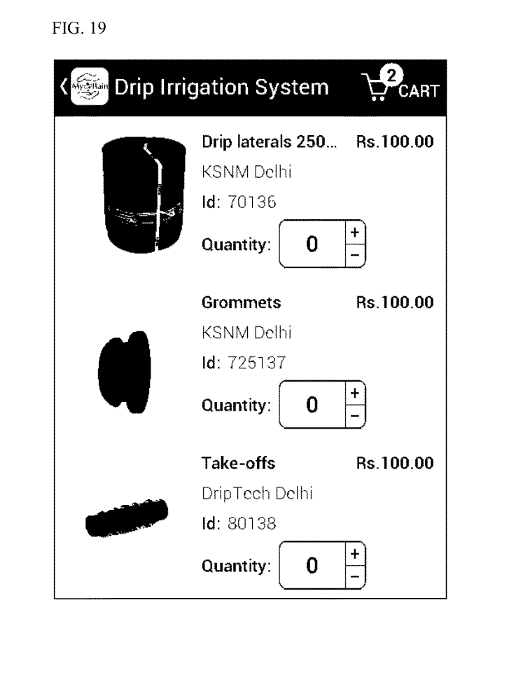

If a user selects the drip irrigation system products option, the application can bring the user to a page that lists the types of drip irrigation system products available for purchase, as illustrated in FIG. 19. The list can include information such as, but not limited to, each product's picture, name, manufacturer, product id, unit price, and the quantity selected for purchase by the user. The page can also display the total number of overall products currently selected for purchase.

In one embodiment, the system may store information about a user's or a customer's inventory so that the user can coordinate when he or she needs to purchase more parts or when a customer needs to purchase more parts. The system may also forecast sales by using information provided by the user to predict future sales. Information that may be provided by the user can include, but is not limited to, average sale price, number of sales per month, number of current customers, and number of potential customers. Lastly, it may enhance customer management by storing information about each customer such as, but not limited to, name, address, phone number, items purchased, and date of purchase.

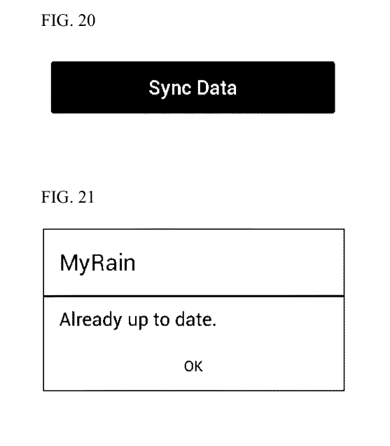

From the main page on the application, as illustrated in FIG. 3, a user can select the settings button to view available settings for the application. FIG. 20 illustrates one embodiment of a portion of the settings page. One option available on the settings page is the ability to sync the application. To synchronize the data, a user can select the sync data button. Once the sync is complete, the page can display a message such as “Already up to date,” as illustrated in FIG. 21.

FIGS. 22 through 31 illustrate features of the disclosed system as a page on a web interface. FIG. 22 is an image that illustrates the login process on the page. The page can require the user to enter a username and password and can offer a user the ability for the system to remember the user when he or she returns to the page on the same device in the future. When the user has provided a valid username and password, he or she can select the sign in button and the page can provide the user access to use the remainder of the application.

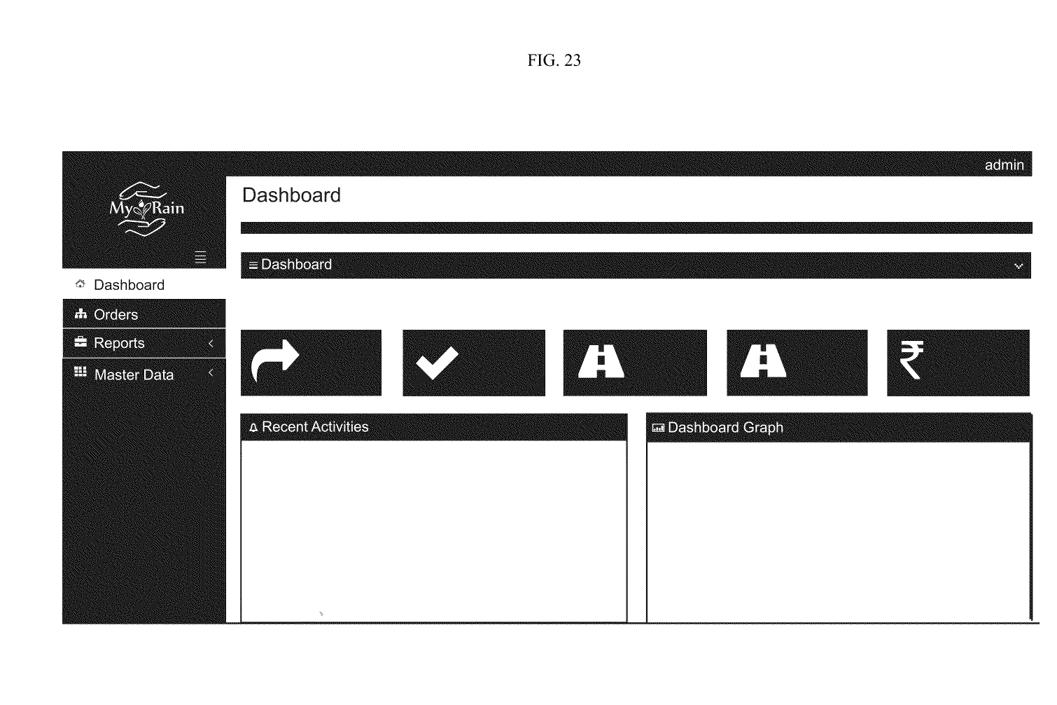

FIG. 23 shows the features that are available on the home page on a web interface. Some features that the page shows as available for the user to select include, but are not limited to, a dashboard page, a user's order page, a report page, and a master data page. A user can select any of these options to be taken to the respective page.

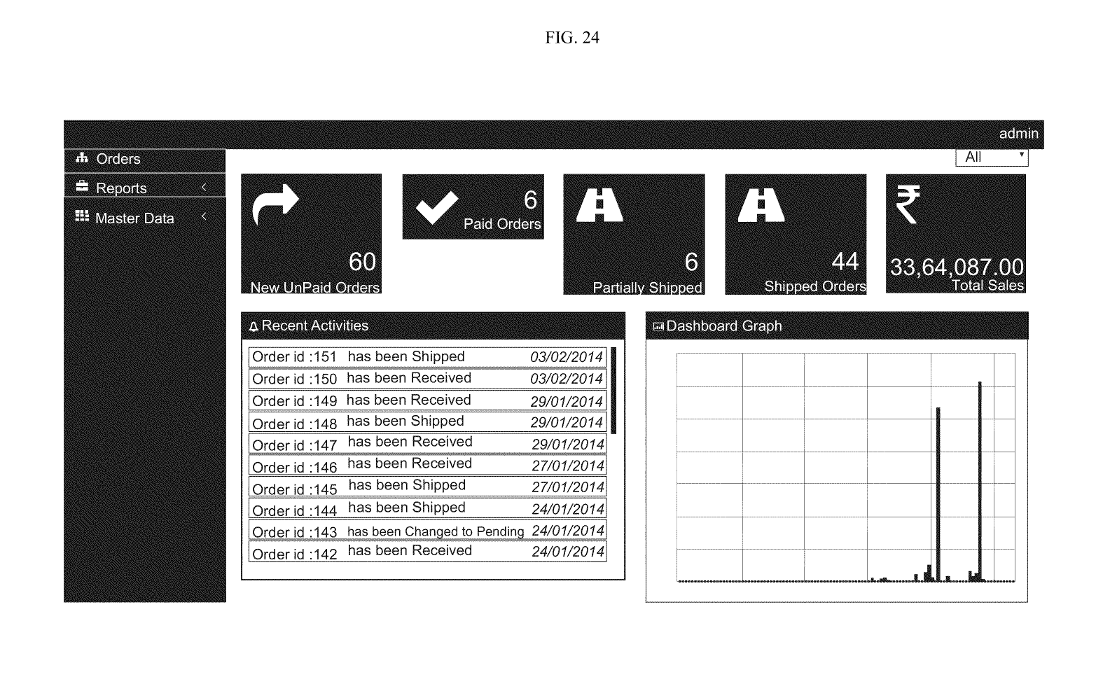

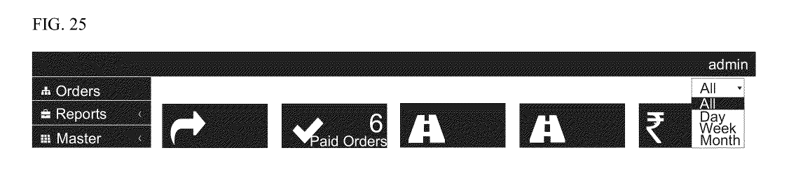

From the home page, as illustrated in FIG. 23, a user can select the dashboard button to view the page's dashboard. FIG. 24 illustrates the dashboard page. The dashboard can display features such as, but not limited to order statistics, recent activities, and a dashboard graph. Available statistics that a user can see include, but are not limited to, the number of new unpaid orders, the number of paid orders, the number of partially shipped orders, the number of shipped orders, and total sales. Recent activity may include a summary of information on orders that have been shipped, received, or that are pending. The dashboard graph may display order history over a recent time period. All of these statistics can be organized if a user decides to filter which statistics are shown, as illustrated in FIG. 25. Filtering can be done by, for example, day, week, or month.

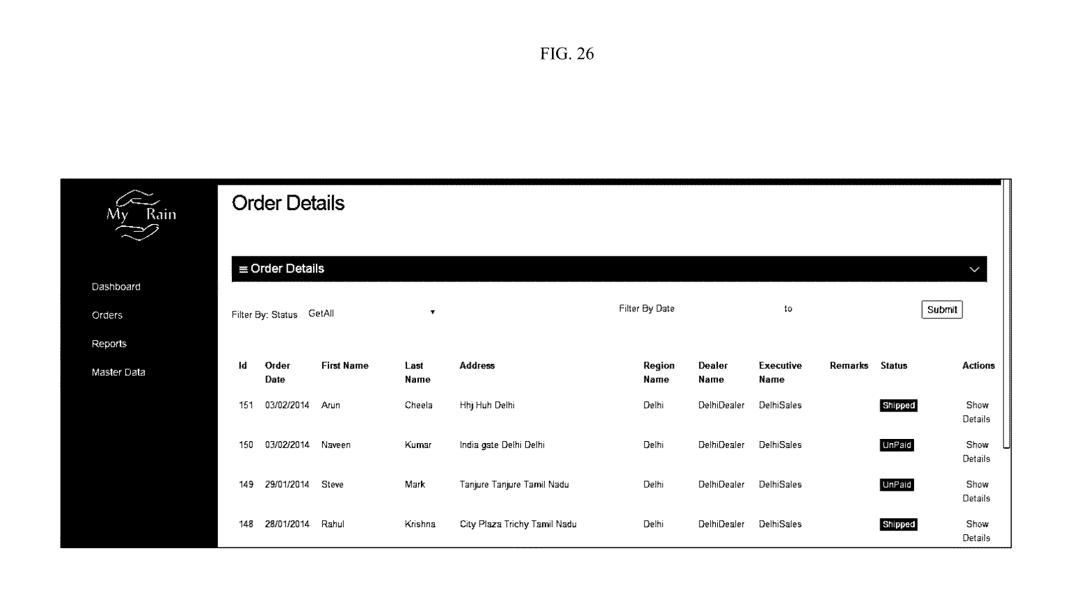

From the home page, as illustrated in FIG. 23, a user can select the orders button to view order details for orders made with the mobile application. FIG. 26 illustrates the order details page. On this page, a user can view a list of orders with information about each order such as, but not limited to, order id, order date, first and last name of the purchaser, the purchaser's address, the region that the purchaser is located in, the dealer's name, the executive's name, any extra remarks, and the status of the order, for example, shipped or unpaid.

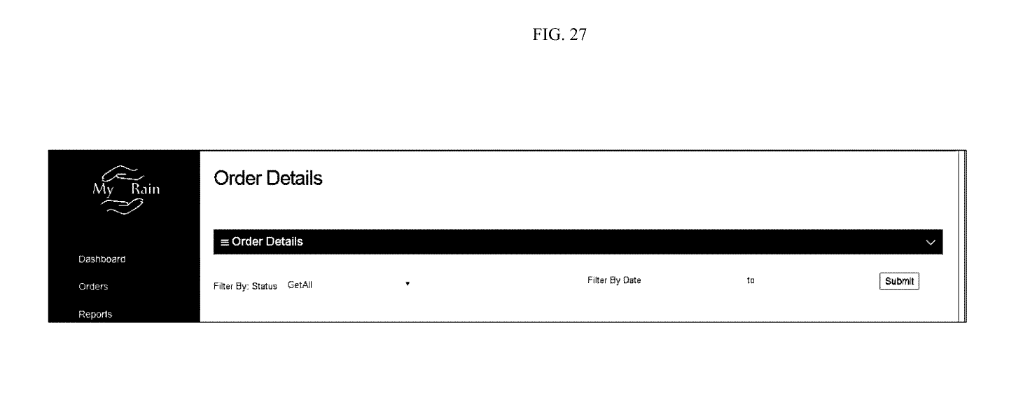

If a user wishes to view orders organized in a specific fashion, he or she can filter the order, as illustrated in FIG. 27. Available options for filtering include, but are not limited to, filter by status and filter by date. To filter by date, a user can input a specific date range or can select a time period, for example, the last 30 days.

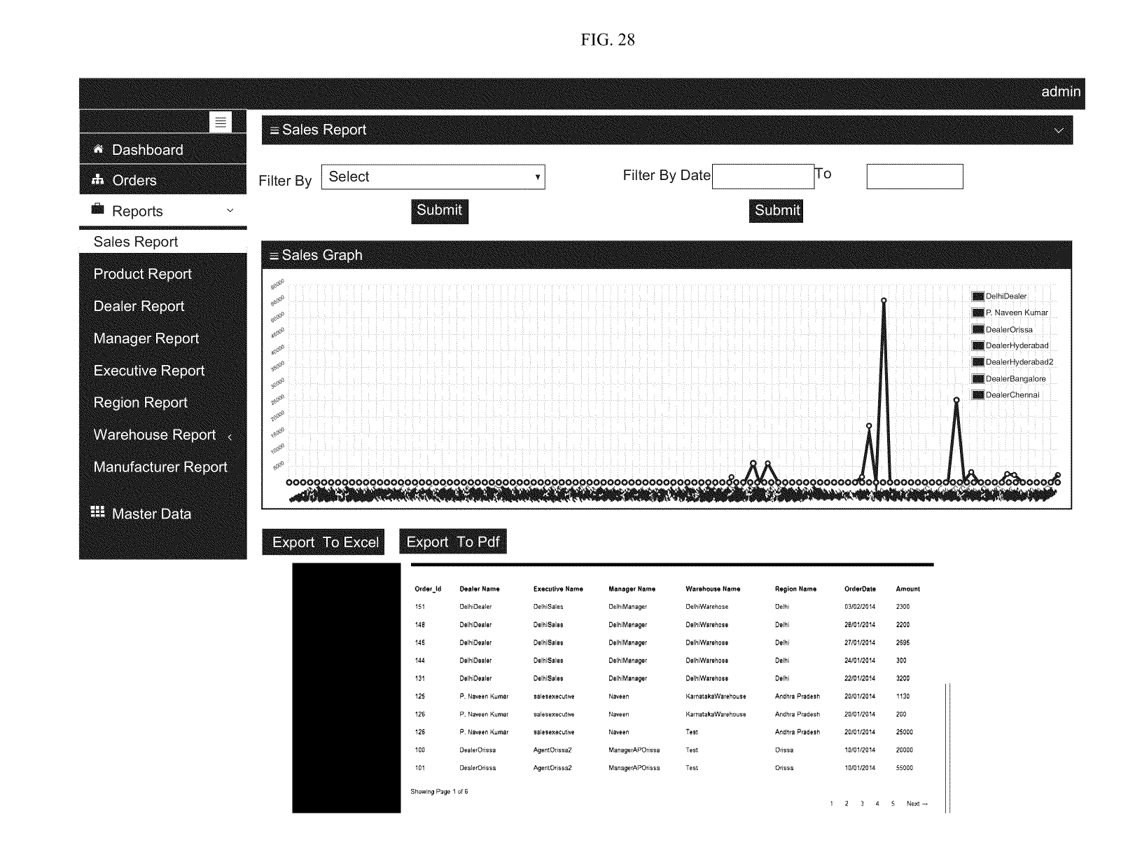

From the home page, as illustrated in FIG. 23, a user can select the reports button to view available reports for the application. FIG. 28 illustrates the main reports page. From this main page, the user can view a number of more specific reports. Each report can contain a graph and related data. The types of reports available include, but are not limited to, sales reports, product reports, dealer reports, manager reports, executive reports, region reports, warehouse reports, and manufacturer reports. The data in each report can include information such as, but not limited to, the order id, dealer name, executive name, manager name, warehouse name, region name, order date, and amount of the order.

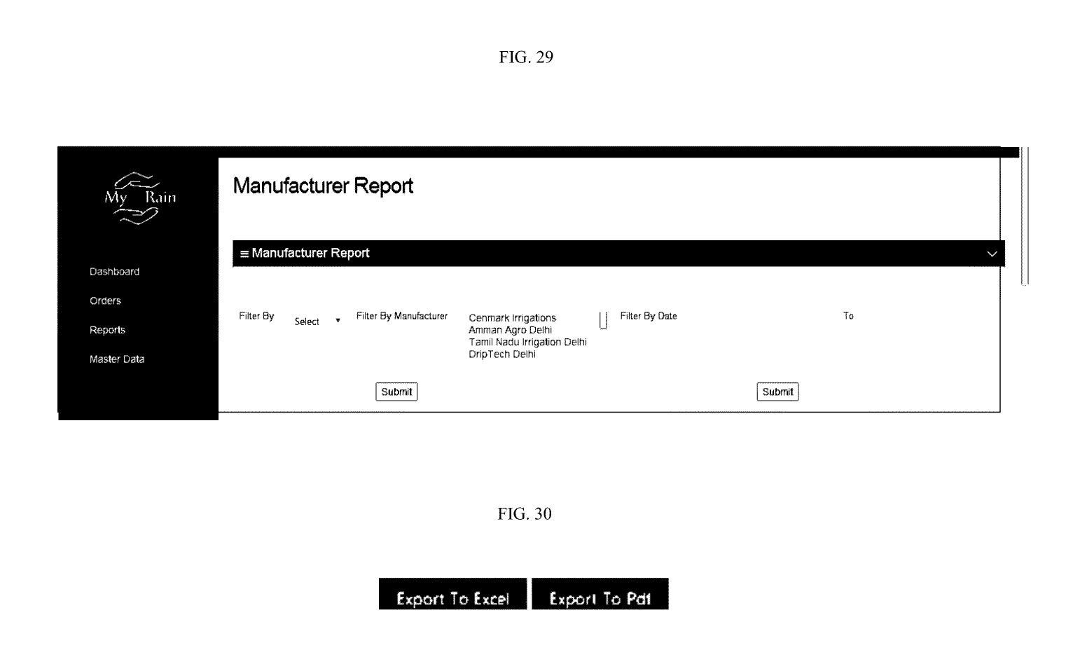

If a user wishes to view reports in a specific fashion, he or she can filter the order, as illustrated in FIG. 29. Available options for filtering include, but are not limited to, filter by status, filter by date, filter by dealer, filter by manager, filter by executive, filter by region, filter by warehouse, and filter by manufacturer. To filter by date, a user can input a specific date range or can select a time period, for example, the last 30 days. Each report can be exported into a spreadsheet or to a PDF document, as illustrated in FIG. 30.

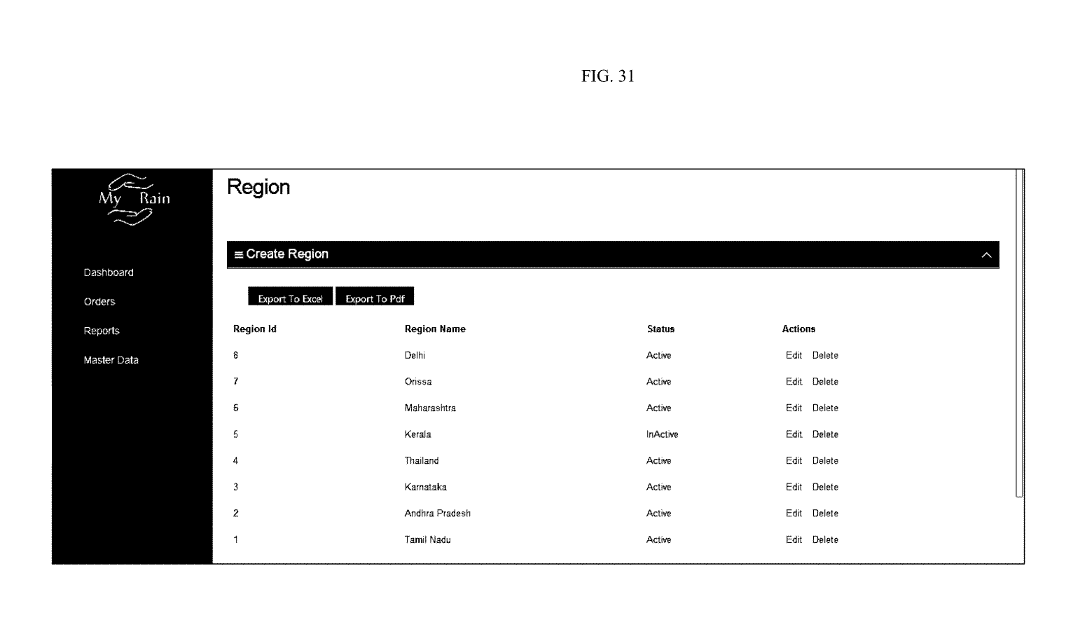

From the home page, as illustrated in FIG. 23, a user can select the master data button to view available data that has been saved by the user. FIG. 31 illustrates the settings page. The data that can be saved includes, but is not limited to, data related to regions, manufacturers, products, managers, executives, dealers, warehouses, and farmers. Master data can be created, edited, and deleted by an administrator. The master data can be exported to a spreadsheet or to a PDF document, as illustrated in FIG. 30.

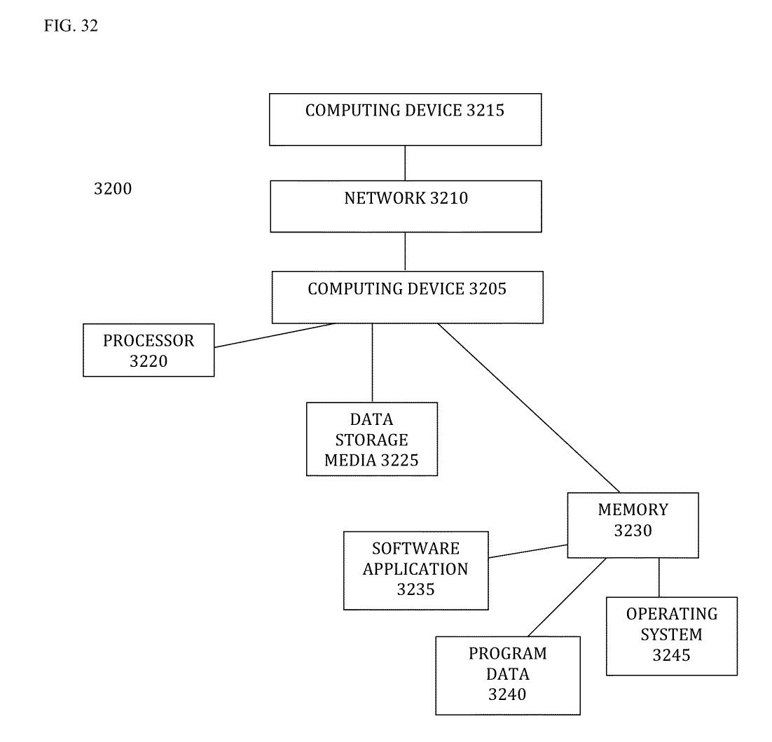

In some embodiments, the system described herein uses a computing system to carry out the various functions described herein. FIG. 32 is a schematic block diagram of an example computing system 3200. The example computing system includes at least one computing device 3202. In some embodiments the computing system further includes a communication network 3204 and one or more additional computing devices 3206 (such as a server).

The computing device 3202 can be, for example, located in a blood bank or hospital or can be a computing device located in a user's home or other place of business. In some embodiments, computing device 3202 is a mobile device. The computing device 3202 can be a stand-alone computing device or a networked computing device that communicates with one or more other computing devices 3206 across a network 3204. The additional computing device(s) 3206 can be, for example, located remotely from the first computing device 3202, but configured for data communication with the first computing device 3202 across a network 3204.

In some examples, the computing devices 3202 and 3206 include at least one processor or processing unit 3208 and system memory 3212. The processor 3208 is a device configured to process a set of instructions. In some embodiments, system memory 3212 may be a component of processor 3208; in other embodiments system memory is separate from the processor. Depending on the exact configuration and type of computing device, the system memory 3212 may be volatile (such as RAM), non-volatile (such as ROM, flash memory, etc.) or some combination of the two. System memory 3212 typically includes an operating system 3218 suitable for controlling the operation of the computing device, such as the WINDOWS® operating systems or the OS X operating system, or a server, such as one employing Windows SharePoint or OS X. The system memory 3212 may also include one or more software applications 3214 and may include program data 3216.

The computing device may have additional features or functionality. For example, the device may also include additional data storage devices 3210 (removable and/or non-removable) such as, for example, magnetic disks, optical disks, or tape. Computer storage media 3210 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices 3202, 3206 can be located in an establishment, such as an office or warehouse. In other examples, the computing device can be a personal computing device that is networked to allow the user to access and utilize the system disclosed herein from a remote location, such as in a user's home, a farmer's land or other location. In some embodiments, the computing device 3202 is a smart phone tablet, laptop computer, personal digital assistant, or other mobile device. In some embodiments system operations and functions are stored as data instructions for a smart phone application. A network 3204 facilitates communication between the computing device 3202 and one or more servers, such as an additional computing device 3206 that hosts the system. The network 3204 may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 3206 is a Web server. In this example, the first computing device 3202 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor of the one or more computing devices 3202 or 606, the instructions cause the processor to perform one or more of the operations or methods disclosed herein. Examples of operations include the ability to design an efficient blueprint layout design of an irrigation system and the ability to provide a list of products for proper installation of an irrigation system, among others.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A system for designing and displaying a drip irrigation system comprising utilizing a computing device having a processing device and a memory device, the memory device storing information that, when executed by the processing device, causes the processing device to:
prompt a user to enter data associated with an agricultural field;
prompt a user to enter data associated with a water pump associated with the agricultural field;
generate system specifications based on the data associated with the agricultural field and the water pump;
evaluate customer water pump capability with regard to system specifications;
generate and display a physical layout of a drip irrigation system;
generate a list of required physical components needed for installation and operation of the drip irrigation system; and
process a purchase order for the list of required physical components.
